(19) United States
(12) Patent Application Publication
(10) Pub. No.: US 2026/0336158 A1
(43) Pub. Date: Oct. 29, 2026

(54) PRESSING TOOL AND METHOD FOR PRODUCING A PRESSING TOOL

(71) Applicant: HUECK Rheinische GmbH, Viersen (DE)

(72) Inventor: Berthold THOELEN, Viersen (DE)

(73) Assignee: HUECK Rheinische GmbH, Viersen (DE)

(21) Appl. No.: 19/735,643

(22) Filed: Jul. 9, 2026

Related U.S. Application Data
(62) Division of application No. 18/874,686, filed on Jun. 28, 2023, now abandoned.

(30) Foreign Application Priority Data
Jun. 30, 2022 (DE) 10 2022 116 423.3

(51) Int. Cl. B27N 3/20; B27N 3/04; B27N 7/00

(52) U.S. Cl. CPC B27N 3/20; B27N 3/04; B27N 7/005

(57) ABSTRACT

Methods for manufacturing a pressing tool for imitating wood and for manufacturing a material panel with a structured surface by pressing are provided. The pressing tool has a support structure made of sheet steel, is formed by a press plate or endless belt and is configured to press material panels in hot presses. The method includes producing a coarse structure with a depth of at least 150 µm operation on the support structure of the pressing tool by at least one processing operation, rounding at least one partial region of the coarse structure by laser polishing such that the partial region of the coarse structure corresponds to a wood grain, and producing a fine structure on a surface of the pressing tool by at least one processing operation. The material panel is pressed with the pressing tool.

### CROSS REFERENCE TO RELATED APPLICATIONS

This application is a divisional of and Applicant claims priority under 35 U.S.C. §§ 120 and 121 of U.S. Patent Application Serial No. 18/874,686 filed on Dec. 13, 2024 which application was a national stage application under 35 U.S.C. §371 of PCT Application No. PCT/EP2023/067626 filed on Jun. 28, 2023, which claimed priority under 35 U.S.C. §119 of German Application No. 10 2022 116 423.3 filed on Jun. 30, 2022, the disclosures of each of which are hereby incorporated by reference. A certified copy of priority German Patent Application No. 10 2022 116 423.3 is contained in parent U.S. Patent Application Serial No. 18,874,686. The International Application under PCT article 21(2) was not published in English.

### BACKGROUND OF THE INVENTION

### 1. Field of the Invention

The invention relates to a pressing tool for imitating wood, a method for manufacturing a pressing tool for imitating wood and a method for manufacturing a material panel.

### 2. Description of the Related Art

Material panels, for example wood-based material panels, are required for the furniture industry and for interior fittings, for example for laminate flooring. The material panels have a core made of MDF (medium-density fiberboard) or HDF (high-density fiberboard), different material supports are placed onto at least one side of said core, for example an (optical) decorative layer and a protective layer (overlay layer).

In order to avoid distortion in the manufactured material panels, such material panels are generally provided with the same number of material supports on both sides in order to connect the individual layers of the material panels (core, material supports, etc.) to one another, these are pressed together in a press using special pressing tools, in particular press plates or endless belts. This also involves surface embossing of the material panels. Hot presses are typically used to bond the various material supports made of thermosetting resins, for example melamine resin, to the surface of the core under the influence of heat by fusing the plastic materials.

In this case, the decorative layers determine the pattern and color scheme of the material panels, yet a desired surface structure can be achieved by using suitable pressing tools. For example, a wood or tile decoration can be printed on the decorative layer (decorative paper), or decorative layers with patterns and color schemes are used that are artistically designed according to the respective intended use. Overlay layers printed on the upper or lower side can also be used in this case.

In order to improve a realistic reproduction, in particular for material panels with wood, tile or natural stone decoration, the pressing tools are provided with a surface structuring that is congruent with the decorative layer and forms a negative image of the desired surface structure. For this reason, the pressing tools have a 3D profile (depth structuring), which is modelled on the wooden veins of a wooden surface, for example, in order to give the decorative layer of the material panel the appearance of such a wooden surface.

In order to achieve congruent embossing of the material panels – i.e. the required fitting accuracy of the decorative layer(s) and surface structure of the material panel, high quality standards are required for the manufacturing the pressing tools. In particular, the press plates or endless belts are used as upper and lower tools in short-cycle presses in this case, which are covered with press plates, or used in double belt presses in endless belts, the material panels being embossed and heated at the same time such that the thermosetting resins of the decorative and/or overlay layers of the material panels are first melted, the surface structure corresponding to the surface structuring of the pressing tools is introduced into the outer material supports, and the structured material supports are bonded to the core of the material panel by subsequent curing.

In order to produce the desired surface structuring in or on the pressing tools, digitalized image data of a decorative template can be used to apply an etch resist for structuring the press plates or endless belts, for example. For this purpose, an etch resist is applied to the press plates or endless belts using a digital printer, for example, in order to subsequently carry out an etching process. After removing the etch resist, further treatment of the pressing tool can be carried out, wherein, preferably in the case of surface structuring with particularly deep/high structures, multiple etching processes can be carried out in succession. For this purpose, an etch resist is applied to the press plate or endless belt already etched itself, and new etching is carried out until the desired depth structure has been produced. In addition, a coarse or fine structuring of the surface structuring can be carried out in the individual etching processes, depending on which surface structure is to be imparted to the material panel.

Alternatively or in addition to the described etching methods or other methods for removing material, it is also possible to use methods for applying material for the (layer-by-layer) manufacturing of the surface structuring on the surface of the pressing tools. Masks (maskings) are used to protect the surface of the pressing tool from subsequent material application or removal in most of these methods. By repeatedly applying corresponding masks and subsequently applying or removing material, surface structuring of a wide variety of designs can be produced.

Regardless of the respective method selected, a surface structuring is finally created on the pressing tool, which forms the negative of the surface structure to be embossed into the material panel. In this case, elevations in the surface structuring correspond to the depressions to be embossed into the surface structure of the material panel, or depressions in the surface structuring correspond to the elevations that the surface structure of the material panel is to have.

In order to improve a realistic reproduction of natural surfaces, in particular for surfaces with wood, tile or natural stone, pressing tools are used that also have varying gloss levels. By setting a respective certain gloss level in a selected surface region of the pressing tool, it is possible to produce any reflections or shading in the material panel, for example, that enhance the impression of a natural wood, tile or natural stone surface for an observer. Thin chromium layers with varying gloss levels, for example, are used for this purpose in the prior art, wherein full-surface chromium plating of the pressing tool surface is firstly carried out, and a further chromium layer is subsequently applied, the further chromium layer covering either only raised or only recessed regions of the surface structuring (EP 3 010 704 B1).

EP 2 839 970 A1 discloses a method for producing hydrophobic or super-hydrophobic surface topography of a pressing tool in the form of a press plate, endless belt or an embossing roller. In order to improve the cleaning of the material panels manufactured with the pressing tools, micro-structuring is provided on the surface.

EP 2 060 658 A2 discloses a method for processing a structured surface of an embossing tool, in which the surface is provided with a first metallic coating over its entire surface in order to simulate wood pores.

EP 2 289 708 A1 discloses a method for manufacturing a surface structure of a metallic press plate, endless belt or an embossing roller using at least one laser, as well as a device for applying the method. A depth structure is created using the laser.

Pressing tools in the form of press plates, endless belts or embossing rollers, for example, comprise a structured pressing surface and are used, in the woodworking industry, for example, to produce furniture, laminates or panels, for example, i.e. general material panels. The material panels are pressed with the structured pressing surface of the pressing tool such that the workpieces receive structured surfaces that correspond to the structured pressing surface.

However, the disadvantage of the methods known in the art is the design limitations, i.e. the imitation of wooden material is yet to be entirely successful, in particular, a desired antique look, i.e. an apparent degree of wear, is not easy to produce. In contrast to a reproduction of a wood and stone finish, the structure does not necessarily follow a pattern. Older natural flooring has significantly rounded and unevenly arranged and shaped regions.

### SUMMARY OF THE INVENTION

The problem to be solved of the present invention is thus to overcome the disadvantages of the prior art and to provide a pressing tool and a method for manufacturing a pressing tool, by means of which the imitation of wood as a material is better achieved, and a degree of wear can be produced more easily.

This problem is solved by a pressing tool, a method for manufacturing a pressing tool device and a method for manufacturing a workpiece according to the claims.

According to a first aspect of an embodiment, a pressing tool for imitating wood, which has a support structure made of sheet steel, is formed from a press plate or endless belt and is configured to press material panels in hot presses. A support structure is to be understood as a load-bearing region of the pressing tool, which is arranged on the non-structured and preferably planar area of the pressing tool, and which is not interspersed with the coarse structure. The support structure preferably has a thickness of at least 500 μm, preferably at least 2000 μm, or particularly preferably between 2000 μm 5000 μm. The support structure of the pressing tool has a coarse structure with a depth of at least 150 µm produced by at least one processing operation, at least a partial region of the coarse structure is rounded by laser polishing and thus corresponds to a wood grain, and the surface of the pressing tool has a fine structure produced by at least one processing operation.

According to a second aspect of the embodiment, a method for manufacturing a pressing tool for imitating wood comprises the steps of producing a coarse structure having a depth of at least 150 µm on the support structure of the pressing tool by at least one processing operation, rounding at least a partial region of the coarse structure by laser polishing such that the partial region of the coarse structure corresponds to a wood grain, and producing a fine structure on the surface of the pressing tool by at least one processing operation. In this case, the pressing tool also has a support structure made of sheet steel, which is formed by a press plate or endless belt and configured to press material panels in hot presses.

According to a third aspect of the embodiment, such a pressing tool is used for pressing the material panel in a method for manufacturing a material panel having a structured surface by pressing.

It has been shown that using the pressing tool and the methods of the first embodiment, the overall impression of a workpiece, i.e. for the pressed laminate, for example, can be designed very individually, and heavily worn wood, for example, can be imitated. Furthermore, it is thereby possible to better imitate the natural appearance of branches.

The further embodiments can relate to any of the aforementioned aspects.

According to a further embodiment, the coarse structure has a depth between 150 µm and 2000 µm. A depth between 150 µm and 1500 µm is particularly preferred.

The laser can be directed at the coarse structure at different angles in this case. The laser can preferably be guided over the coarse structure with adjustable parameters, such as removal capacity and an adjustable speed as well as variable distance. Certain areas of the coarse structure, such as sharp edges or larger areas of the coarse structure, can particularly preferably be selectively processed. In this case, the laser can be controlled according to a 3D data set or a grayscale file of the desired rounding of the pressing tool. Areas to be processed more would appear darker in the grayscale file, for example. In the case of the grayscale file, individual parameters of the laser setting can preferably be assigned to individual grayscale values.

According to a further embodiment, one or more coatings are applied to the entire surface or part of the surface of the support structure, and the surface of the pressing tool is formed by the surface of the uppermost full-surface coating or by the uppermost partial surfaces of the partial-surface coatings. In the method, one or more coatings are applied to the entire area or to part of the area of the support structure before the coarse structure is produced.

According to a further embodiment, at least one region of the surface of the pressing tool has a first gloss level.

According to a further embodiment, at least one further region of the surface of the pressing tool has a second gloss level different to the first gloss level.

According to another embodiment, each of the coatings is either metallic, ceramic or contains plastic.

According to a further embodiment, at least one of the coatings is a chromium layer or a nickel-plated or nickel-containing coating.

According to a further embodiment, at least one region of at least one coating is formed by laser processing, matte etching, sandblasting, or chemical treatment.

According to another embodiment, the edges of at least one coating are broken by heavy polishing.

According to a further embodiment, at least one of the processing operations comprises one or more of pressing, embossing, etching, polishing, laser processing, grinding, milling, and applying a further coating, or a combination thereof.

According to a further embodiment, at least one coating is applied to the support structure by chemical deposition.

The embodiments show possible design variants, however the invention is not restricted to the design variants of the same specifically shown, rather any combinations of the individual design variants are very much possible.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

### The figures show in greatly simplified, schematic depiction:

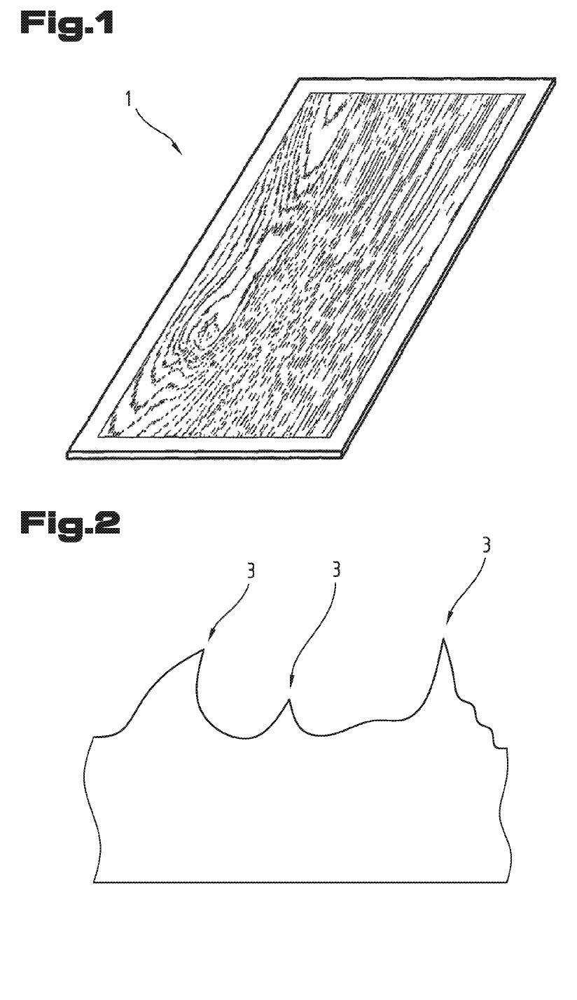

FIG. 1 shows an exemplary pressing tool according to an embodiment;

FIG. 2 shows an exemplary coarse structure according to an embodiment;

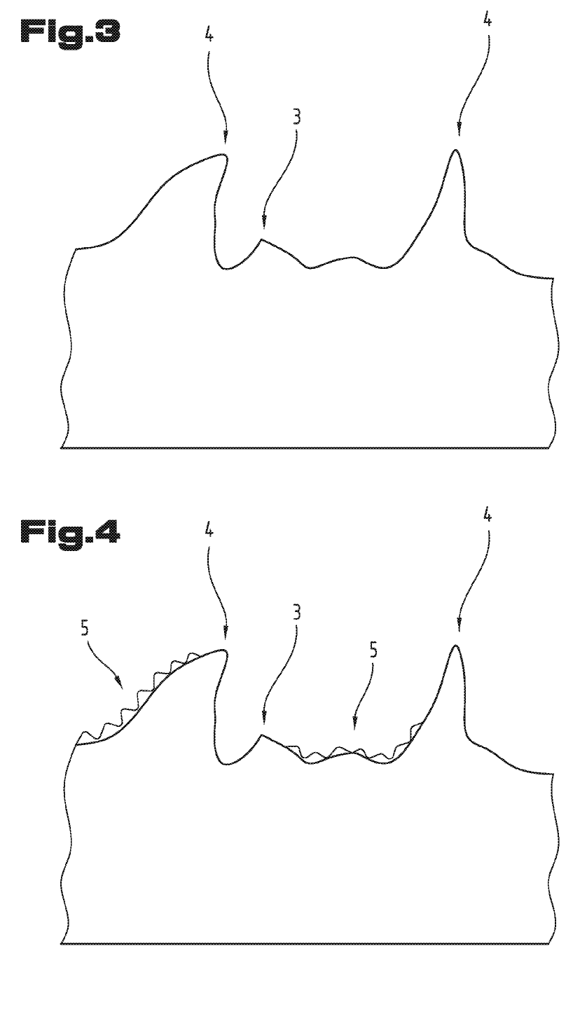

FIG. 3 shows an exemplary rounded coarse structure according to an embodiment; and

FIG. 4 shows an exemplary fine structure according to an embodiment.

### DETAILED DESCRIPTION OF PREFERRED EMBODIMENTS

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. also refer to the figure directly described and shown, and these indications of position can be applied in the same way to the new position should the position change.

FIG. 1 shows a pressing tool 1 for imitating wood with a structure applied thereto, which transfers the structure to the workpiece when a workpiece is pressed with the pressing tool 1, for example in a hot press. As a result, the structure, which corresponds to the grain of a wood, for example, can be transferred onto the workpiece. By doing so, the workpiece obtains a wood finish; i.e. it looks like wood.

In order to create this structure on the pressing tool 1, the pressing tool 1, which can be a press plate or an endless belt, for example, is processed. This processing operation can be performed as one of sand blasting, chemical treatment, pressing, embossing, etching, polishing, laser processing, grinding, milling, and applying coatings, or one of a combination of several thereof.

FIG. 2 shows a coarse structure on the support structure of the pressing tool 1 produced by at least one processing operation in cross section. The processing depth is at least 150 µm in this case. The processing depth can be a depth between 150 µm and 2000 µm, a depth between 150 µm and 1500 µm being particularly preferred.

In this case, each processing operation can be performed as one of sand blasting, chemical treatment, pressing, embossing, etching, polishing, laser processing, grinding, milling, and applying coatings, or one of a combination of several thereof.

FIG. 2 also shows that the coarse structure has sharp edges at some points 3 or is very angular in its configuration.

FIG. 3 shows a rounded coarse structure of the pressing tool 1 in cross section. At least a partial region of the coarse structure is rounded by laser polishing. Laser polishing rounds the edges of the coarse structure or of partial regions thereof, which means it is possible to give the coarse structure or partial regions thereof a softer appearance. Another advantage in this case is that the tactile elements change, and the softer edges further enhance the similarity to wood.

The relief of the coarse structure is rounded by laser polishing in this case. In this case, either the relief of the entire coarse structure of the pressing tool 1 is rounded by laser polishing or only the reliefs of the partial regions of the coarse area of the pressing tool 1.

During laser polishing, thin edge layers of the structure are rounded by the active principle of remelting and smoothing the then liquid material as a result of the interfacial tension. Solid-state lasers can be used for laser polishing, for example. Depending on the state of the surface to be rounded, pulsed lasers with pulse durations of a few hundred nanoseconds or continuous lasers can be used.

The use of a laser for polishing enables automated rounding of three-dimensional surfaces with equivalent rounding quality. This achieves in particular a higher processing speed compared to manual polishing. This can further ensure reproducibility; i.e. all pressing tools can be identical.

In addition, laser polishing results in a low mechanical load on the pressing tool 1 since laser polishing is a contactless process. This also means that no grinding or polishing waste is produced, and no grinding or polishing agent thus need be worked into the surface.

FIG. 3 shows that some of the formerly sharp edges or angular points 3 are rounded; these are designated as rounded points 4.

FIG. 4 shows a fine structure 5 produced on the rounded coarse structure in cross section. In this case, the fine structure 5 is produced by at least one processing operation on the surface of the pressing tool 1.

In this case, each processing operation can also be performed as one of sand blasting, chemical treatment, pressing, embossing, etching, polishing, laser processing, grinding, milling, and applying coatings, or one of a combination of several thereof.

In order to manufacture such a pressing tool 1, the coarse structure is firstly produced on the support structure of the pressing tool 1 by at least one processing operation. At least a partial region of the coarse structure is subsequently rounded by laser polishing. A fine structure 5 is then produced on the surface of the pressing tool 1 by at least one processing operation.

As explained above, each of the processing operations can also be performed as one of sand blasting, chemical treatment, pressing, embossing, etching, polishing, laser processing, grinding, milling, and applying coatings, or one of a combination of several thereof.

Alternatively or in addition to what is described above, one or more coatings can be applied to the entire surface or to part of the surface of the support structure. The surface of the pressing tool 1 is then formed by the surface of the uppermost full-surface coating or by the uppermost partial surfaces of the partial-surface coatings. In this case, a plurality of partial areas can form a total area of the surface.

In this case, the coating or coatings can be applied before the coarse structure is produced such that the coarse structure is produced in the coatings. However, the coatings can also be applied only after the coarse structure has been produced in the support structure of the pressing tool 1. Coatings can even also be applied after rounding by polishing and before the fine structure 5 is produced. Finally, coatings can also be applied after the fine structure 5 has been produced.

As a result, a first gloss level can be generated in one or more regions of the surface of the finished pressing tool 1. In this case, this region or these regions can be those in which a coarse structure has been rounded, but these can also be regions that have not been changed further by the rounding.

However, the gloss levels can alternatively also be generated by processing. In this case, each such processing operation can also be performed as one of sand blasting, chemical treatment, pressing, embossing, etching, polishing, laser processing, grinding, milling, and applying coatings, or one of a combination of several thereof.

By applying different coatings or by different processing operations of a coating, at least one further region of the surface of the pressing tool 1 can have a second gloss level different to the first gloss level. Two different gloss levels can also be generated by processing one or more regions and leaving one or more regions unprocessed or uncoated.

Each of these coatings can be metallic, ceramic, or contain plastic. Coatings that contain plastic are described in DE 10 2019 127 659 A1, for example, in which paint or plastic layers are described, preferably comprising polyether ether ketone or polyether ether ketone, optionally also with the addition of mineral particles.

At least one of the coatings can be a chromium layer or a nickel-plated or nickel-containing coating. In addition, one or more areas of the coatings can be formed by laser processing, matte etching, sandblasting, or chemical treatment. Furthermore, the edges of at least one coating can also be broken by heavy polishing. This polishing can also be laser polishing.

Each coating described above can also be applied by chemical deposition. As described above, each coating can be applied to the support structure without a structure, to the coarse structure, to the (partially) rounded coarse structure and also to the fine structure.

Finally, it is worth mentioning again that each of the processing operations can also be performed as one of sand blasting, chemical treatment, pressing, embossing, etching, polishing, laser processing, grinding, milling, and applying coatings, or one of a combination of several thereof.

In order to produce a workpiece, i.e. a material panel, using the pressing tool thus manufactured, a pressing method is used to manufacture a material panel with a structured surface, wherein a pressing tool as described above is used to press the material panel.

The embodiments show possible design variants, however it is noted at this point that the invention is not restricted to the design variants of the same specifically shown, rather various combinations between the individual design variants are possible and these possible variants can be developed using the knowledge of the person skilled in the art working in this field based on the teachings of technical practice offered by the current invention.

The scope of protection is determined by the claims. However, the description and the drawings are to be referenced for the interpretation of the claims. Individual features or combinations of features from the various exemplary embodiments shown and described can represent independent inventive solutions in themselves. The problem to be solved, upon which the independent, inventive solutions are based, can be derived from the description.

All value ranges specified in the current description are to be understood such that they include any and all sub-ranges e.g. the specification 1 to 10 is to be understood such that all sub-ranges, starting from the lower limit 1 and the upper limit 10 are included i.e. all sub-ranges begin with a lower limit of 1 or more and end at an upper limit of 10 or less e.g. 1 to 1.7, or 3.2 to 8.1 or 5.5 to 10.

As a matter of form and by way of conclusion, it is noted that, to improve understanding of the structure, elements have partially not been shown to scale and/or enlarged and/or shrunk.

### List of reference numerals:

1 Pressing tool

3 Sharp edges or angular points

4 Rounded points

5 Fine structure

What is claimed is:

1. A method for manufacturing a pressing tool for imitating wood, wherein the pressing tool has a support structure made of sheet steel, is formed by a press plate or endless belt and is configured to press material panels in hot presses, the method comprising the steps of:
producing a coarse structure with a depth of at least 150 µm operation on the support structure of the pressing tool by at least one processing operation,
rounding at least one partial region of the coarse structure by laser polishing such that the partial region of the coarse structure corresponds to a wood grain, and
producing a fine structure on a surface of the pressing tool by at least one processing operation.

2. The method according to claim 1, wherein producing the coarse structure produces a coarse structure having a depth between 150 µm and 2000 µm, particularly preferably having a depth between 150 µm and 1500 µm.

3. The method according to claim 1, further comprising generating a first gloss level in at least one region of the surface of the pressing tool.

4. The method according to claim 1, further comprising generating a second gloss level different to the first gloss level in at least one further region of the surface of the pressing tool.

5. The method according to claim 1, further comprising prior to production of the coarse structure:
fully or partially applying one or more coatings to the support structure, whereby the surface of the pressing tool is formed by a surface of an uppermost full-surface coating or by an uppermost partial surfaces of the partial-surface coatings.

6. The method according to claim 5, wherein each of the coatings is either metallic, ceramic or contains plastic.

7. The method according to claim 5, wherein at least one of the coatings is a chromium layer or a nickel-plated or nickel-containing coating.

8. The method according to claim 5, further comprising forming at least one region of at least one of the coatings by laser processing, matte etching, sandblasting, or chemical treatment.

9. The method according to claim 5, further comprising breaking the edges of at least one of the coatings by heavy polishing.

10. The method according to claim 5, further comprising applying at least one of the coatings to the support structure by chemical deposition.

11. The method according to claim 1, wherein at least one of the processing operations comprises one or more of pressing, embossing, etching, polishing, laser processing, grinding, milling, and applying a further coating, or a combination thereof.

12. A method for manufacturing a material panel with a structured surface by pressing, comprising the steps of:
providing a pressing tool for imitating wood, which has a support structure made of sheet steel, is formed by a press plate or endless belt and is configured to press material panels in hot presses, wherein the support structure of the pressing tool has a coarse structure produced by at least one processing operation with a depth of at least 150µm, at least one partial region of the coarse structure is rounded by laser polishing and thus corresponds to a wood grain, and the surface of the pressing tool has a fine structure produced by at least one processing operation; and
pressing the material panel with the pressing tool.
